(19) United States
(12) Patent Application Publication
(10) Pub. No.: US 2009/0238920 A1
(43) Pub. Date: Sep. 24, 2009

(54) Process for making high grade protein product

(76) Inventor: Ted C. Lewis, Sikeston, MO (US)

Correspondence Address: PAULEY PETERSEN & ERICKSON, 2800 WEST HIGGINS ROAD, SUITE 365, HOFFMAN ESTATES, IL, 60169, US

(21) Appl. No.: 12/383,157

(22) Filed: Mar. 20, 2009

Related U.S. Application Data
(60) Provisional application No. 61/038,688, filed on Mar. 21, 2008.

(51) Int. Cl. A23K 1/06; A23K 1/18; A23K 1/16

(52) U.S. Cl. 426/20; 426/31; 426/19

(57) ABSTRACT

A process for making a high grade protein product, such as a mammalian feed product, using residue slurry from a cellulose fermentation and distillation process is provided. The residue slurry is compressed to remove much of the residual liquid. The compressed slurry is shaped, dried, leavened and granulated to provide the high grade protein product. Nutrients, flavorants, texturizers and other food product-enhancing ingredients may be added during the process. The granules of animal feed product can be packaged and stored in an inert or other stable environment for extended storage periods.

### RELATED APPLICATIONS

This application claims priority under 35 U.S.C. §119(e) to U.S. Provisional Application Ser. No. 61/038,688, filed on 21 Mar. 2008, the disclosure of which is incorporated by reference.

### FIELD OF THE INVENTION

This invention is directed to a process for making high grade protein product, such as a mammalian feed product, from a residual mixture of distilled grains, distilled dried grains, alcohol and other residual liquids formed during the conversion of starch and sugar to alcohol in a biomass distillation process.

### BACKGROUND OF THE INVENTION

Typical cellulose plant fermentation processes use catalysts, enzymes and/or yeast to convert starch and/or cellulose into sugars for fermentation. The fermentation product typically includes a mixture of alcohol, yeast, enzymes, water, carbon dioxide, and grain and/or cellulose residues. The mixture is distilled to volatilize and remove much of the alcohol. The remaining residue is typically in the form of a biomass slurry (whole stillage) that also includes residual alcohol, yeast, enzymes, water and carbon dioxide. Known energy intensive water removal processes result in distilled grains (“DG”) called wet cake, and distilled dried grains with solubles (“DDGS”).

Wet distiller's residue spoils rapidly without drying or specialized and expensive preservation measures. The high cost of transporting heavy wet biomass residue generally prohibits its use more than 100 miles from the biorefinery. Various energy-intensive techniques have been employed to partially dry the residue, but generally do not achieve product moisture contents below about 10% by weight. Conventional heat drying technologies can damage the residue and its nutritional value, and do not convert the residue to a multi-use, very dry, storage-stable product.

### SUMMARY OF THE INVENTION

The present invention is directed to a process and apparatus for making a high grade protein product, such as a mammalian feed product, by converting the protein-rich residue slurry following fermentation and distillation into a dry, crunchy, partially leavened protein-rich product with less energy expenditure than known art. The term “high grade protein product” refers generally to a product that is both rich in protein and storage-stable. The process includes the steps of providing a residual slurry, compressing the residual slurry (suitably under devolatilizing vacuum) to remove liquids without adding heat and form a compressed product, shaping the compressed product into one or more strands, further drying the compressed product to a low moisture content, and granulating the one or more strands to form the granulated high grade low moisture protein product. The high grade protein product can have many uses, such as a mammalian feed product, and can be formed from any fermentation and distillation residue. Residual alcohol may cause some leavening of the product during the shaping and subsequent heating steps. The leavening contributes to a lightweight, crunchy nature of the protein product. If the product is used for feed, then flavor enhancers, nutrients, texture modifiers and material to precipitate or chemically bind some unwanted nutrient components can be added during the process. The residual liquid removed during the compression step can be further distilled to separate the residual alcohol from the liquid.

The process of the invention permits processing of the residual biomass slurry at any location, including its point of collection, due to its energy efficiency and size compared to conventional processes. Because the resulting product has low moisture content, it can be stored for long periods without spoiling.

With the foregoing in mind, it is a feature and advantage of the invention to provide a process for making low moisture, high grade protein feed product from the residual biomass slurry of a fermentation and distillation process. It is also a feature and advantage of the invention to provide a process which converts the fermentation and distillation residue into a product having a profitable yield, which can be practiced at the site where the biomass slurry is generated. It is also a feature and advantage of the invention to provide the process at low energy cost.

### BRIEF DESCRIPTION OF THE DRAWINGS

FIG. 1 schematically illustrates a block diagram of the process of the invention.

FIG. 2 schematically illustrates an apparatus useful to practice the process of the invention in a continuous fashion.

FIG. 3 schematically illustrates an alternative apparatus useful to practice the process of the invention in a continuous fashion.

### DETAILED DESCRIPTION OF THE INVENTION

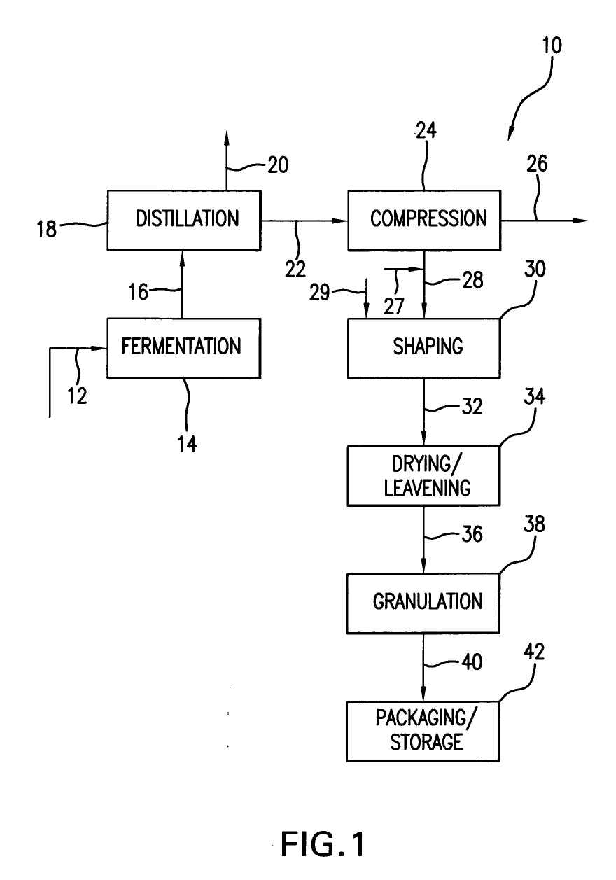

Referring to FIG. 1, a process 10 for making the high grade protein product is illustrated. Initially, hydrolysate formed from cellulose or starch conversion to sugars is directed via inlet 12 into a fermentation tank 14 where it is combined with yeast which converts sugars into alcohol useful for fuel and other purposes. The hydrolysate can be derived from various sources of starch or cellulose, including without limitation wood from trees, such as pine soft wood and other kinds of softwood and hardwood; food plants, such as corn, wheat, barley and soybeans; grasses; and other sources of starch and cellulose.

The fermentation product mixture exits the fermentation process via stream 16 and can include a mixture of alcohol, cellulose, grain residue, enzymes and/or yeast, water, carbon dioxide and possibly other by-products and ingredients. The fermentation product mixture is fed via stream 16 to a distillation process 18, which may include one or more conventional distillation columns for distilling much of the alcohol. The distillation process 18 employs evaporative techniques, such as heat and vacuum, to volatilize and remove much of the alcohol product through exit stream 20. The residue from the distillation process exits via stream 22. The residue may include a combination of a plurality of ingredients selected from distiller's grains (“DG's”), dissolved sugars and proteins (“solubles”), residual alcohol, water, carbon dioxide, yeast, enzymes, and other by-products and ingredients. The DG's and solubles are often rich in protein and have potential nutritional value.

The following process steps, taken alone or in combination with the foregoing fermentation and distillation steps, are considered to define the invention. The residue from the distillation process is fed to suitable compression apparatus 24 which compresses the residue under vacuum to remove much of the residual alcohol, water and other liquid through exit 26. A compressed residual product is formed, which contains much less liquid, which exits the compression apparatus via stream 28. Whereas the residue entering the compression apparatus 24 via stream 22 may have a liquid content of greater than about 80 percent by weight, the compressed residual product that exits via stream 28 may have a much reduced liquid content of about 3 to about 8 percent by weight.

In one embodiment, flavor enhancers, nutrients, texture modifiers and other food product-enhancing ingredients can be added into the residue stream 22 before or during the compression step. In order to avoid having the food product-enhancing ingredients removed in large part via liquid stream 26, it may be more advantageous to add them at later stages of the process 10, for example, into compressed residue stream 28 via inlet stream 27, or into shaping apparatus 30 via inlet stream 29. Exemplary flavor enhancers include without limitation grain extracts, synthetic flavors, mineral salts, and combinations thereof. Exemplary nutrients include without limitation vitamins, minerals, proteins, and combinations thereof. Exemplary texture modifiers include without limitation grain extracts, proteins, synthetic additives, and combinations thereof. Other food product-enhancing ingredients include without limitation organic and inorganic precipitants, texture modifiers, and combinations thereof.

The compressed residue enters shaping apparatus 30 via stream 28. The shaping apparatus shapes the compressed residue into one or more strands. The strands may have any elongated, relatively narrow shape that is suitable for subsequent drying and granulation. The strands may have a cross-section that is circular, ellipsoidal, square, rectangular, triangular, parabolic or otherwise, and may have an average diameter of about 1 to about 30 centimeters.

The strands may exit the shaping apparatus 30 via stream 32 and enter a drying apparatus 34 which typically employs heat, with or without vacuum, to dry the strands. The drying apparatus 34 may employ heated air or inert gas at a temperature of about 30° C. to about 180° C., for a time of about 1 to about 10 seconds, to accomplish sufficient drying of the elongated strands. Convection and/or vacuum may also be employed to facilitate drying of the strands. The strands should be dried to a moisture content of less than about 3% by weight, suitably less than about 2% by weight, or less than about 1% by weight, or less than about 0.5% by weight, or less than about 0.2% by weight.

Residual alcohol in the strands may facilitate leavening (expansion) of the elongated strands in the drying apparatus. The leavening helps the resulting high grade protein product develop a lightweight, texturized, crunchy constituency.

In an alternative embodiment, described further below, the compressed residue may be dried, such as by flash drying, and then shaped into strands before being cut. In other words, the order of steps may be varied to suit the specific processing techniques employed.

The dried elongated strands exit the drying apparatus 34 via stream 36 and are granulated into high grade protein product particles using a granulation device 38, which can be a conventional mechanical shearing device or pelletizer. As explained below, the drying and pelletizing can also be accompanied using an apparatus that has been optimized for explosive drying and air cooling. The resulting particles travel via stream 40 into a package or other storage device 42. The drying, processing and storage of the high grade protein product particles greatly extends their storage life for useful purposes. Carbon dioxide from the fermentation process can be used in the storage containers to further stabilize the product particles during storage. If desired, nitrogen and other inert or stabilizing gases can also be injected into the package or other storage device.

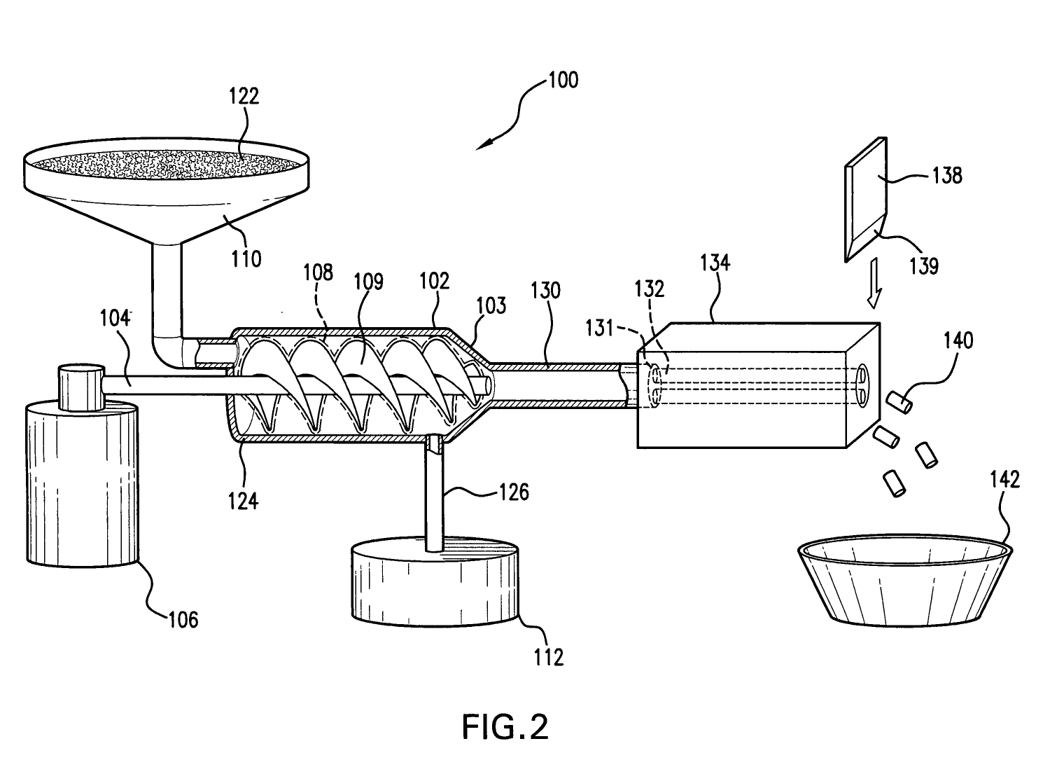

FIG. 2 illustrates an apparatus 100 for continuously making the high grade protein product particles from a residue that includes a plurality of ingredients selected from DG's, DDGS's, residual alcohol, water, carbon dioxide, yeast, enzymes, and other by-products and ingredients. The residue 122 that is processed by the apparatus 100 of FIG. 2 may be the same residue that is supplied by stream 22 shown in FIG. 1. The residue 122, typically a slurry, may be fed continuously from a hopper 110 into a compression extruder 124 which performs the compression step 24, illustrated in FIG. 1. The compression extruder 124 includes a housing 102 having a diameter which becomes progressively narrower toward a distal end 103, a drive shaft 104 driven by motor 106, and a screw press 108 having plates 109 whose diameters become progressively narrower toward the distal end 103 of the housing 102. The plates 109 may also become progressively smaller in pitch toward the distal end 103.

The screw press 124 may also include internal mixing paddles and/or screw flights to convey the slurry residue forward. As the slurry residue 122 is conveyed forward in the compression extruder 124, the changing geometry of plates 109 squeezes and compresses the slurry residue 102 causing residual liquid to exit through channel 126 into tank 112. Vacuum may also be applied to the compression extruder 124 to remove further liquid. The liquid entering tank 112 can then be processed for further separation and distillation of alcohol from the liquid.

The compressed residue from the screw press 124 enters a narrower shaping module 130 where it is continuously extruded into shaped residue configured as a plurality of elongated narrow strands 132. The pressure built up in the compression extruder 124 drives the extrusion through the shaping module 130. In one embodiment, the plates 109 can be configured to define specific compartments in the screw press 124 such as one or more compartments mainly for removing liquids, one or more compartments for accepting food-enhancing ingredients, one or more compartments for compression and shaping, etc. One suitable extruder for screw press 124 which can employ plates to define compartments is a PAMA ROMA® extruder available from Parsi Macchine s.r.l. of San Cesario, Italy. The shaping module 30 may be in the form of an elongated extrusion barrel which is equipped with an extrusion die 131, and which is adapted to engage the downstream end of screw press 124. The shaping is performed by continuously extruding the compressed residue through extrusion die 131.

The strands 132 from the shaping module 130 are continuously passed through a drying and leavening chamber 134 which can be a temperature-controlled block formed of steel or another metal. While in the chamber 134, the strands 132 are exposed to heated gas at a sufficient temperature and for a sufficient time to dry the strands 132 to a desired low moisture content. One advantage of the chamber 134 is that the residence time under heat may be controlled to facilitate controlled leavening (expansion) of the strands 132 due to the action of residual alcohol, yeast and/or enzymes.

Upon exiting the drying and leavening chamber 134, the strands 132 are continuously cut into granules or pellets 140 using a mechanical granulating device or pelletizer 138 having a cutting edge 139. The granules 140 of animal feed product are deposited into a package or other storage device 142. Because the granules 140 are substantially dry, they can be stored for extended periods without experiencing moisture-induced degradation. Residual carbon dioxide from the fermentation process may also aid storage stability. Carbon dioxide, nitrogen or other inert gas may also be added to the package for enhanced storage stability.

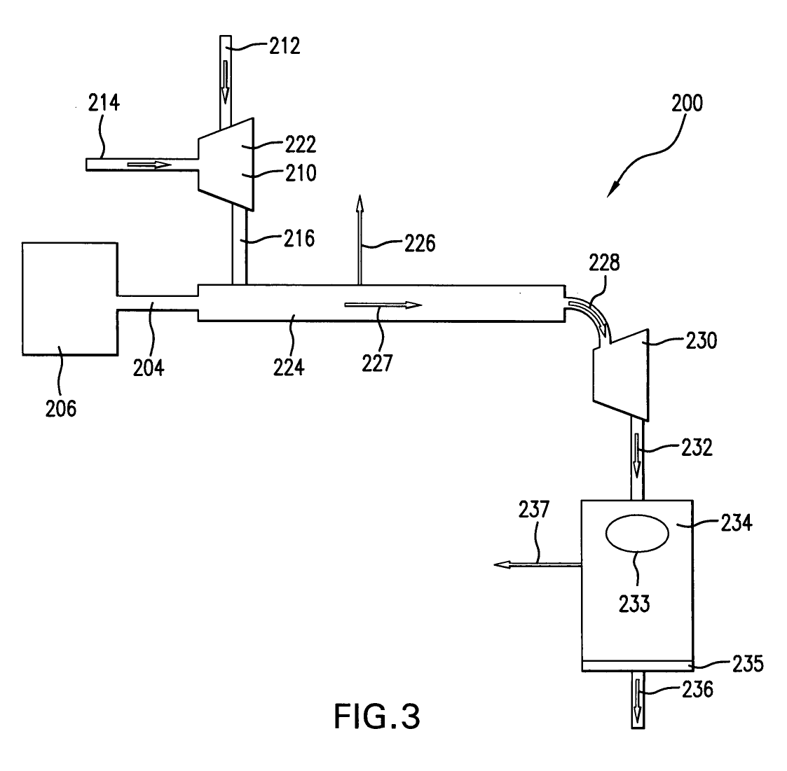

FIG. 3 illustrates an alternative apparatus 200 for carrying out the process of the invention. A mixer hopper 210 contains a residue 222 that includes a plurality of ingredients selected from DG's, DDGS's, residual alcohol, water, carbon dioxide, yeast, enzymes, and other by-products and ingredients. The residue 222 can be fed to the mixer hopper using inlet 212, and can include the residue supplied by stream 22 shown in FIG. 1. The residue 222 can also include, or be combined with nutrients, precipitating agents and other additives fed to the mixer hopper via inlet 214.

The residue mixture is fed from the mixer hopper via outlet 216 into a compression apparatus which, in this embodiment, can be a twin screw extruder 224 driven by a drive motor 206 and drive shaft 204. Twin screw extruders are designed to accommodate a variety of screw configurations tailored for specific purposes. Twin screw extruder 224 is designed for mixing and compression of the ingredients, and includes a vacuum port at the location of arrow 226. The vacuum port communicates with one or more vacuum pumps (not shown) to devolatalize and remove large amounts of water, in the form of water vapor, from the residue slurry. As the water vapor is removed, the residue mixture experiences decreasing viscosity and higher pressure as it is conveyed forward in the direction of arrow 227.

The residue mixture passes from twin screw extruder 224 through channel 228 and pressure pump 230, which raises the pressure in the mixture to between about 250 and about 3000 psi. The residue mixture then passes through channel 232 into a flash drying chamber 234 and enters a compression zone 233 in the chamber 234. While in the compression zone 233, or immediately prior thereto, the residue mixture is combined with compressed, heated gas such as air or carbon dioxide, at a pressure of about 250 to about 3000 psi and a temperature of about 65° C. to about 180° C. The subsequent release of pressure as the residue mixture leaves compression zone 233 results in rapid decompression and explosive “flash” drying in the chamber 234. The residual water vapor leaves chamber 234 through outlet 237. The resulting dried high grade protein product, which has a moisture content of less than about 3% by weight, passes through extrusion plate 235 in the form of one or more strands 236, and can be granulated as described with respect to FIG. 2.

Notably, the embodiment of FIG. 3 performs the drying step in flash drying chamber 234 before the shaping step, which is largely performed as the dried compressed residue passes through extrusion plate 235. The explosive flash drying results in a high grade protein product having a low moisture content which can be less than about 2% by weight, suitably less than about 1% by weight, or less than about 0.5% by weight, or less than about 0.2% by weight, or less than about 0.1% by weight, or less than about 0.05% by weight, or less than about 0.02% by weight. The low moisture content enhances the storage stability of the high grade protein product by alleviating moisture-induced spoilation.

The embodiments of the invention described herein are exemplary. Various modifications and improvements can be made without departing from the spirit and scope of the invention. The scope of the invention is indicated in the appended claims, and all changes that fall within the meaning and range of equivalents are intended to be embraced therein.

I claim:

1. A process for making a high grade protein product from the residue of cellulose plant fermentation and distillation, comprising the steps of:
providing a residue that comprises a plurality of ingredients selected from the group consisting of distiller's grains, dried distiller's grains, residual alcohol, water, carbon dioxide, yeast, enzymes and combinations thereof;
compressing the residue to remove liquid ingredients and provide a compressed residue;
shaping the compressed residue to provide one or more strands;
drying the compressed residue; and
granulating the dried strands to provide granules of high grade protein product.

2. The process of claim 1, further comprising the step of leavening the one or more strands.

3. The process of claim 2, wherein the drying and leavening occur simultaneously.

4. The process of claim 1, further comprising the step of adding one or more product-enhancing ingredients selected from the group consisting of flavor enhancers, nutrients, texture modifiers and combinations thereof.

5. The process of claim 4, wherein the product-enhancing ingredients are added to the residue before or during the compressing step.

6. The process of claim 1, wherein the step of drying the residue is performed before the step of shaping the residue.

7. The process of claim 1, wherein the step of shaping the residue is performed before the step of drying the residue.

8. The process of claim 1, wherein the step of shaping the compressed residue is performed by extruding the compressed residue through an extrusion die.

9. The process of claim 1, wherein the high grade protein product has a moisture content of less than about 2% by weight.

10. A process for making a high grade protein product from the residue of cellulose plant fermentation and distillation, comprising the steps of:
providing a residue slurry that comprises a plurality of ingredients selected from the group consisting of distiller's grains, dried distiller's grains, residual alcohol, water, carbon dioxide, yeast, enzymes and combinations thereof;
continuously compressing the residue slurry to remove liquid ingredients and provide a compressed residue;
continuously shaping the compressed residue to provide one or more strands;
continuously drying the compressed residue; and
continuously granulating the strands to provide granules of high grade protein product.

11. The process of claim 10, further comprising the step of continuously leavening the strands.

12. The process of claim 10, further comprising the step of continuously adding one or more food product-enhancing ingredients selected from the group consisting of flavor enhancers, nutrients, texture modifiers and combinations thereof.

13. The process of claim 10, further comprising the step of adding inert gas to the granules to facilitate long-term storage.

14. The process of claim 10, wherein the residue slurry is continuously provided from a distillation process.

15. The process of claim 10, wherein the distiller's grains and dried distiller's grains are derived from cellulose plant feed selected from the group consisting of wood from trees, food plants, grasses, and combinations thereof.

16. The process of claim 10, wherein the high grade protein product has a moisture content of less than about 2% by weight.

17. A process for making high grade protein product from the residue of cellulose plant fermentation and distillation, comprising the steps of:
feeding a residue'slurry into an extruder, the residue slurry comprising a plurality of ingredients selected from the group consisting of distiller's grains, dried distiller's grains, residual alcohol, water, carbon dioxide, yeast, enzymes, and combinations thereof;
compressing the residue slurry in the extruder to remove liquid ingredients and provide a compressed residue;
shaping the compressed residue by extruding the compressed residue through an extrusion die;
drying the compressed residue; and
granulating the compressed residue to provide granules of high grade protein product.

18. The process of claim 17, wherein the drying is performed by exposing the strands to heated gas.

19. The process of claim 17, wherein the drying is performed by treating the compressed residue with compressed, heated gas followed by rapid decompression.

20. The process of claim 17, further comprising the step of adding one or more food product-enhancing ingredients to the extruder.
